(19) United States
(12) Patent Application Publication
(10) Pub. No.: US 2020/0218653 A1
(43) Pub. Date: Jul. 9, 2020

(54) CONTROLLER, DATA STORAGE DEVICE, AND OPERATING METHOD THEREOF

(71) Applicant: SK hynix Inc., Gyeonggi-do (KR)

(72) Inventor: Tae Kyu RYU, Gyeonggi-do (KR)

(21) Appl. No.: 16/557,493

(22) Filed: Aug. 30, 2019

(30) Foreign Application Priority Data
Jan. 9, 2019 (KR) 10-2019-0002682

(51) Int. Cl. G06F 12/02

(52) U.S. Cl. CPC G06F 12/0253; G06F 2212/7205; G06F 2212/1044

(57) ABSTRACT

A data storage device includes a nonvolatile memory apparatus including a plurality of memory blocks, and a controller configured to control the nonvolatile memory apparatus. The controller determines update frequency for data stored in first memory blocks of the plurality of memory blocks, controls the nonvolatile memory apparatus to store target data of the data stored in the plurality of memory blocks in second memory blocks, of the plurality of memory blocks, the target data indicating data having the update frequency exceeding preset threshold update frequency, sets garbage collection execution conditions of the first memory blocks and the second memory blocks to be different from each other, and controls the nonvolatile memory apparatus to perform garbage collection for the first memory blocks and the second memory blocks according to the garbage collection execution conditions set to be different from each other.

### CROSS-REFERENCES TO RELATED APPLICATION

The present application claims priority under 35 U.S.C. § 119(a) to Korean application number 10-2019-0002682, filed on Jan. 9, 2019, which is incorporated herein by reference in its entirety.

### BACKGROUND

### 1. Technical Field

Various embodiments generally relate to a semiconductor apparatus, and more particularly, to a controller, a data storage device, and an operating method thereof.

### 2. Related Art

Recently, a paradigm for a computer environment has been changed to ubiquitous computing which enables a computer system to be used anytime and anywhere. Therefore, the use of portable electronic devices such as cellular phones, digital cameras, and notebook computers is rapidly increasing. Such portable electronic devices generally use a data storage device using a memory apparatus. The data storage device is used to store data for the portable electronic devices.

The data storage device using the memory apparatus is advantageous in that stability and durability are superior due to the absence of a mechanical driving unit, an information access speed is very fast, and power consumption is small. The data storage device having such advantages includes a universal serial bus (USB) memory apparatus, a memory card having various interfaces, a universal flash storage (UFS) device, and a solid state drive (SSD).

### SUMMARY

An efficient garbage collection technology capable of improving the performance, lifetime and the like of a data storage device is described herein.

In an embodiment, a data storage device may include: a nonvolatile memory apparatus including a plurality of memory blocks; and a controller configured to control the nonvolatile memory apparatus, wherein the controller may determine update frequency for data stored in first memory blocks of the plurality of memory blocks, control the nonvolatile memory apparatus to store target data of the data stored in the plurality of memory blocks in second memory blocks of the plurality of memory blocks, the target data indicating data having the update frequency exceeding a preset threshold update frequency, set garbage collection execution conditions of the first memory blocks and the second memory blocks to be different from each other, and control the nonvolatile memory apparatus to perform garbage collection for the first memory blocks and the second memory blocks according to the garbage collection execution conditions set to be different from each other.

In an embodiment, a controller for controlling a nonvolatile memory apparatus including a plurality of data storage areas may include: a memory configured to store a flash translation layer; and a processor configured to execute the flash translation layer stored in the memory, wherein the flash translation layer may include: an update frequency determination module configured to determine update frequency for data stored in first memory blocks of the plurality of memory blocks; a first control module configured to control the nonvolatile memory apparatus to store target data of the data stored in the plurality of memory blocks in second memory blocks, the target data indicating data having the update frequency exceeding a preset threshold update frequency; a garbage collection setting module configured to set garbage collection execution conditions of the first memory blocks and the second memory blocks to be different from each other; and a second control module configured to control the nonvolatile memory apparatus to perform garbage collection for the first memory blocks and the second memory blocks according to the garbage collection execution conditions set to be different from each other.

In an embodiment, an operating method of a data storage device including a nonvolatile memory apparatus including a plurality of memory blocks and a controller for controlling the nonvolatile memory apparatus may include the steps of: determining, by the controller, update frequency for data stored in first memory blocks of the plurality of memory blocks; storing, by the nonvolatile memory apparatus, target data of the data stored in the plurality of memory blocks in second memory blocks, the target data indicating data having the update frequency exceeding preset threshold update frequency; setting, by the controller, garbage collection execution conditions of the first memory blocks and the second memory blocks to be different from each other; and performing, by the nonvolatile memory apparatus, garbage collection for the first memory blocks and the second memory blocks according to the garbage collection execution conditions set to be different from each other.

In accordance with an embodiment, it is possible to improve the performance and lifetime of a data storage device through efficient garbage collection.

### BRIEF DESCRIPTION OF THE DRAWINGS

FIG. 1 is a diagram illustrating a configuration of a data storage device in accordance with an embodiment.

FIG. 2 is a diagram illustrating a configuration of a memory of FIG. 1.

FIG. 3 is a diagram for describing data storage areas included in a nonvolatile memory apparatus in accordance with an embodiment.

FIG. 4 is a diagram for describing a flash translation layer in accordance with an embodiment.

FIG. 5 is a flowchart of an operating method of the data storage device in accordance with an embodiment.

FIG. 6 is a flowchart of the operating method of the data storage device in accordance with an embodiment.

FIG. 7 is an exemplary diagram illustrating a data processing system including a solid state drive (SSD) in accordance with an embodiment.

FIG. 8 is an exemplary diagram illustrating a configuration of a controller of FIG. 7.

FIG. 9 is an exemplary diagram illustrating a data processing system including a data storage device in accordance with an embodiment.

FIG. 10 is an exemplary diagram illustrating a data processing system including a data storage device in accordance with an embodiment.

FIG. 11 is an exemplary diagram illustrating a network system including a data storage device in accordance with an embodiment.

FIG. 12 is an exemplary block diagram illustrating a nonvolatile memory apparatus included in a data storage device in accordance with an embodiment.

### DETAILED DESCRIPTION

Hereinafter, embodiments will be described in detail with reference to the accompanying drawings.

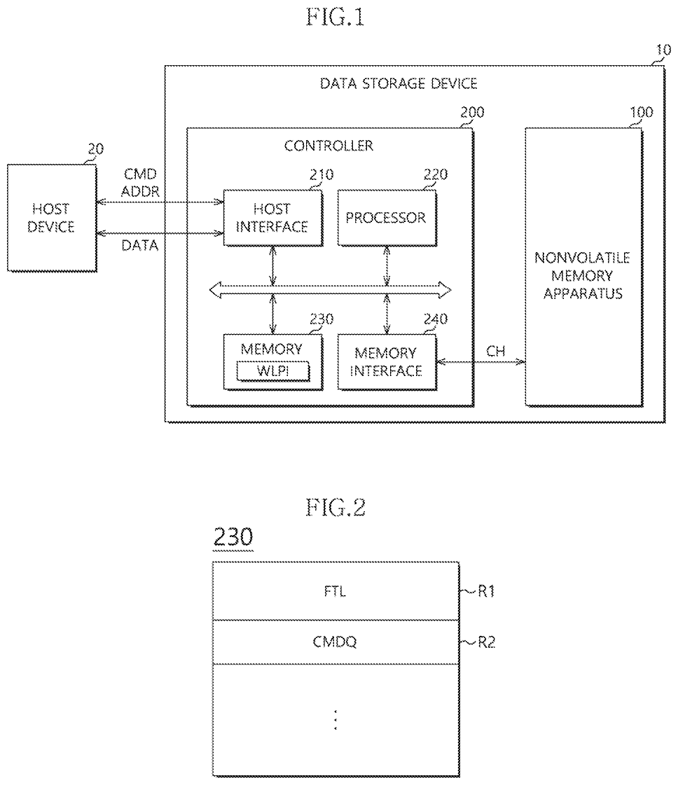

FIG. 1 is an exemplary diagram illustrating a configuration of a data storage device 10 in accordance with an embodiment.

Referring to FIG. 1, the data storage device 10 in accordance with the present embodiment may store data which is accessed by a host device 20 such as a cellular phone, an MP3 player, a laptop computer, a desktop computer, a game machine, a television, an in-vehicle infotainment system. The data storage device 10 may be called a memory system.

The data storage device 10 may be fabricated as any one of various types of storage devices electrically connected to the host device 20 according to an interface protocol. For example, the data storage device 10 may be configured as any one of various types of storage devices such as a multimedia card in the form of a solid state drive (SSD), an MMC, an eMMC, an RS-MMC, or a micro-MMC, a secure digital card in the form of an SD, a mini-SD, or a micro-SD, a universal serial bus (USB) storage device, a universal flash storage (UFS) device, a storage device in the form of a personal computer memory card international association (PCMCIA) card, a storage device in the form of a peripheral component interconnection (PCI) card, a storage device in the form of a PCI express (PCI-e or PCIe) card, a compact flash (CF) card, a smart media card, and a memory stick.

The data storage device 10 may be fabricated as any one of various types of packages. For example, the data storage device 10 may be fabricated as any one of various types of packages such as a package on package (POP), a system in package (SIP), a system on chip (SOC), a multi-chip package (MCP), a chip on board (COB), a wafer-level fabricated package (WFP), and a wafer-level stack package (WSP).

The data storage device 10 may include a nonvolatile memory apparatus 100 and a controller 200.

The nonvolatile memory apparatus 100 may operate as a storage medium of the data storage device 10. The nonvolatile memory apparatus 100 may be configured as any one of various types of nonvolatile memory apparatuses, such as a NAND flash memory apparatus, a NOR flash memory apparatus, a ferroelectric random access memory (FRAM) using a ferroelectric capacitor, a magnetic random access memory (MRAM) using a tunneling magneto-resistive (TMR) film, a phase change random access memory (PRAM) using chalcogenide alloys, and a resistive random access memory (ReRAM) using a transition metal oxide, according to memory cells.

FIG. 1 illustrates that the data storage device 10 includes one nonvolatile memory apparatus 100; however, the data storage device 10 may include a plurality of nonvolatile memory apparatuses and an embodiment can also be equally applied to the data storage device 10 including a plurality of nonvolatile memory apparatuses.

The nonvolatile memory apparatus 100 may include a memory cell array (not illustrated) having a plurality of memory cells arranged in intersection areas of a plurality of word lines (not illustrated) and a plurality of bit lines (not illustrated). The memory cell array may include a plurality of memory blocks and each of the plurality of memory blocks may include a plurality of pages.

For example, each memory cell of the memory cell array may be a single level cell (SLC) that stores one bit of data or a multi-level cell (MLC) capable of storing two or more bits of data. The multi-level cell (MLC) may store two bits of data, three bits of data, four bits of data and the like. In general, a memory cell that stores two bits of data is called a multi-level cell (MLC), a memory cell that stores three bits of data is called a triple-level cell (TLC), and a memory cell that stores four bits of data is called a quadruple-level cell (QLC). However, in the present embodiment, for convenience of explanation, a memory cell that stores two to four bits of data will be generally called a multi-level cell (MLC).

The memory cell array may include at least one of the single level cell (SLC) and the multi-level cell (MLC). Furthermore, the memory cell array may also include memory cells having a two-dimensional horizontal structure or memory cells having a three-dimensional vertical structure.

The controller 200 may control all operations of the data storage device 10 by driving firmware or software loaded on a memory 230. The controller 200 may decode and drive a code type instruction or an algorithm such as firmware or software. The controller 200 may be implemented as hardware or a combination of hardware and software.

The controller 200 may include a host interface 210, a processor 220, the memory 230, and a memory interface 240. Although not illustrated in FIG. 1, the controller 200 may further include an error correction code (ECC) engine that generates a parity data by ECC-encoding write data provided from the host device and ECC-decodes read data read from the nonvolatile memory apparatus 100 by using the parity data.

The host interface 210 may serve as an interface between the host device 20 and the data storage device 10 corresponding to the protocol of the host device 20. For example, the host interface 210 may communicate with the host device 20 through any one of various protocols such as a universal serial bus (USB), a universal flash storage (UFS), a multimedia card (MMC), a parallel advanced technology attachment (PATA), a serial advanced technology attachment (SATA), a small computer system interface (SCSI), a serial attached SCSI (SAS), a peripheral component interconnection (PCI), and a PCI express (PCIe).

The processor 220 may be composed of a micro control unit (MCU) and a central processing unit (CPU). The processor 220 may process requests transmitted from the host device 20. To process the requests transmitted from the host device 20, the processor 220 may drive the code type instruction or algorithm loaded on the memory 230, that is, the firmware, and control internal function blocks such as the host interface 210, the memory 230, and the memory interface 240, and the nonvolatile memory apparatus 100.

The processor 220 may generate control signals for controlling the operation of the nonvolatile memory apparatus 100 on the basis of the requests transmitted from the host device 20, and provide the generated control signals to the nonvolatile memory apparatus 100 through the memory interface 240.

The memory 230 may be composed of a random access memory such as a dynamic random access memory (DRAM) and a static random access memory (SRAM). The memory 230 may store the firmware that is driven by the processor 220. Furthermore, the memory 230 may store data required for driving the firmware, for example, meta data. That is, the memory 230 may operate as a working memory of the processor 220.

The memory 230 may include a data buffer for temporarily storing write data to be transmitted from the host device 20 to the nonvolatile memory apparatus 100, or read data to be transmitted from the nonvolatile memory apparatus 100 to the host device 20. That is, the memory 230 may operate as a buffer memory.

The memory interface 240 may control the nonvolatile memory apparatus 100 under the control of the processor 220. The memory interface 240 may also be called a memory controller. The memory interface 240 may provide the control signals to the nonvolatile memory apparatus 100. The control signals may include a command, an address, an operation control signal and the like for controlling the nonvolatile memory apparatus 100. The memory interface 240 may provide the nonvolatile memory apparatus 100 with the data stored in the data buffer, or may store the data transmitted from the nonvolatile memory apparatus 100 in the data buffer.

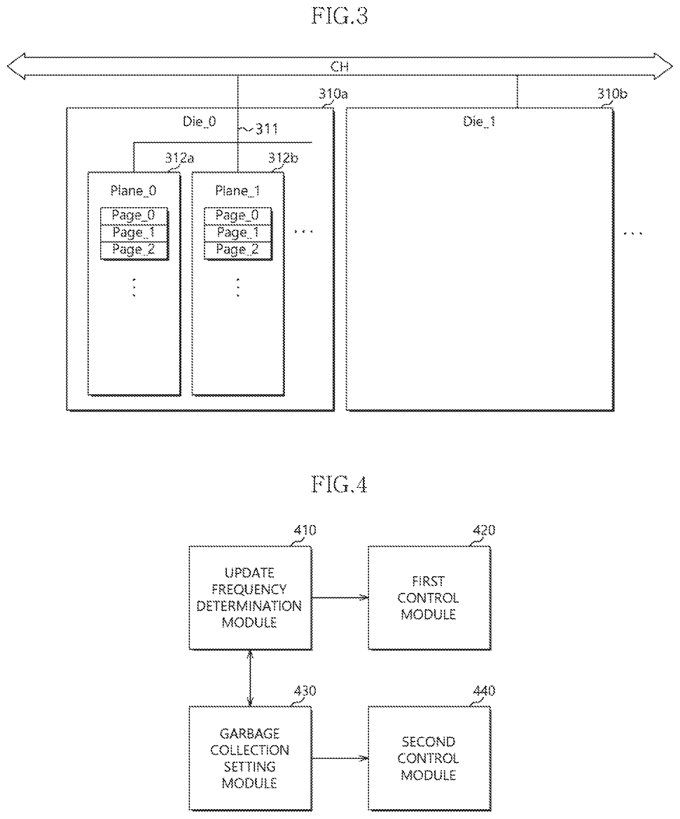

FIG. 2 is a diagram illustrating the memory 230 of FIG. 1.

Referring to FIG. 2, the memory 230 in accordance with the present embodiment may include a first region R1 where a flash translation layer (FTL) is stored, and a second region R2 used as a command queue (CMDQ) for queuing commands corresponding to the requests provided from the host device 20. However, it is obvious to those skilled in the art that the memory 230 may include regions used for various purposes such as a region used as a write data buffer for temporarily storing write data, a region used as a read data buffer for temporarily storing read data, and a region used as a map cache buffer in which map data is cached, in addition to the regions illustrated in FIG. 2.

Furthermore, the memory 230 may include a region (not illustrated) where system data, meta data and the like are stored. The workload pattern information (WLPI) of FIG. 1 may be stored in a region where the system data, the meta data and the like of the memory 230 are stored.

When the nonvolatile memory apparatus 100 is configured as a flash memory apparatus, the processor 220 may control a unique operation of the nonvolatile memory apparatus 100, and drive software called the flash translation layer (FTL) in order to provide device compatibility to the host device 20. Through the driving of the flash translation layer (FTL), the host device 20 may recognize and use the data storage device 10 as a general storage device such as a hard disk.

The flash translation layer (FTL) stored in the first region R1 of the memory 230 may include modules for performing various functions, and meta data required for driving each module. The flash translation layer (FTL) may be stored in a system region (not illustrated) of the nonvolatile memory apparatus 100, or may be read from the system region of the nonvolatile memory apparatus 100 and loaded on the first region R1 of the memory 230 when the data storage device 10 is powered on.

FIG. 3 is a diagram for describing data storage areas included in the nonvolatile memory apparatus in accordance with an embodiment.

Referring to FIG. 3, the nonvolatile memory apparatus 100 may include a plurality of dies 310a and 310b sharing a channel electrically connected to the controller 200, each die may include a plurality of planes 312a and 312b sharing a way 311 electrically connected to the channel, and each plane may include a plurality of data pages. The data page may refer to a minimum storage area for reading or writing data. Furthermore, a plurality of data page units in which erase operations are simultaneously performed are referred to as a block, and a plurality of block units managed as one are referred to as a super block. Accordingly, the data storage areas in the nonvolatile memory apparatus 100 may refer to the die, the plane, the super block, the block, the data page and the like; however, unless otherwise stated, the following description will be given on the assumption that the data storage area refers to a block that is a unit in which garbage collection is performed.

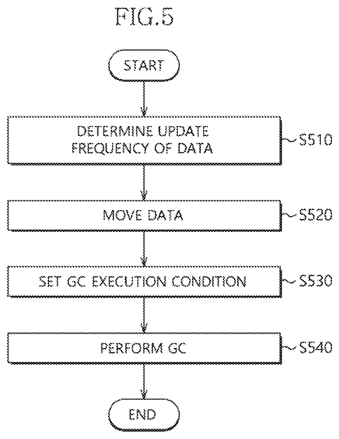

FIG. 4 is a diagram for describing the flash translation layer in accordance with an embodiment.

Referring to FIG. 4, the flash translation layer in accordance with the embodiment may include an update frequency determination module 410, a first control module 420, a garbage collection setting module 430, and a second control module 440.

The update frequency determination module 410 may determine update frequency of data. As a specific example, the update frequency determination module 410 may determine update frequency such as the number of updates and the update cycle of data stored in the plurality of data storage areas included in the nonvolatile memory apparatus 100.

In an embodiment, the update frequency determination module 410 may determine the update frequency of data based on a logical address. For example, the update frequency determination module 410 may determine, as the update frequency, the number of references of a logical address referred to in order to store data in the nonvolatile memory apparatus 100. This is because it is necessary to perform an operation for storing updated data in a second data storage area in order to update data stored in a first data storage area in a non-over table memory apparatus and the logical address of the data to be updated is referred to at this time. In such a case, the number of references of data stored in a data storage area corresponding to the referred logical address may be stored as meta data and the like.

The first control module 420 may control the nonvolatile memory apparatus 100 to store, in the second data storage area, the data stored in the first data storage area. As a specific example, the first control module 420 may control the nonvolatile memory apparatus 100 to store, in the second data storage area, hot data of the data stored in the first data storage area, the hot data indicating data having the update frequency exceeding preset threshold update frequency. The second data storage area may refer to a data storage area different from the first data storage area among the data storage areas stored in the nonvolatile memory apparatus 100.

In an embodiment, the first control module 420 may change the threshold update frequency. As a specific example, the first control module 420 may change the threshold update frequency to be low when the erase and/or write count of the first data storage area is high. Furthermore, the first control module 420 may change the threshold update frequency to be high when the erase and/or write count of the first data storage area is low.

In an embodiment, when a write operation for updating the hot data is performed, the first control module 420 may control the nonvolatile memory apparatus to store the hot data in the second data storage area.

In an embodiment, when a garbage collection operation is performed for the first data storage area storing the hot data, the first control module 420 may control the nonvolatile memory apparatus to store the hot data in the second data storage area.

In an embodiment, the first control module 420 may determine a data storage area, which has a higher reliability than the first data storage area among the plurality of data storage areas, as the second data storage area. For example, the first control module 420 may determine a data storage area, which has a smaller number of erases or writes than the first data storage area, as the second data storage area. Furthermore, the first control module 420 may determine a data storage area capable of more erase or write operations than the first data storage area as the second data storage area.

The garbage collection setting module 430 may set a garbage collection (GC) execution condition of the nonvolatile memory apparatus 100 based on the update frequency of data. As a specific example, when plural pieces of data having different update frequencies are stored for respective data storage areas, the garbage collection setting module 430 may set different garbage collection execution conditions for the respective data storage areas based on the update frequency of stored data.

In an embodiment, the garbage collection setting module 430 may set the number of invalid data as the garbage collection execution condition. For example, when setting the number of invalid data as the garbage collection execution condition, the garbage collection setting module 430 may set the number of invalid pages, which is the garbage collection execution condition of the second data storage area, to be larger than the number of invalid pages which is the garbage collection execution condition of the first data storage area.

In an embodiment, the garbage collection setting module 430 may set the number of valid data as the garbage collection execution condition. For example, when setting the number of valid data as the garbage collection execution condition, the garbage collection setting module 430 may set the number of valid pages, which is the garbage collection execution condition of the second data storage area, to be smaller than the number of valid pages which is the garbage collection execution condition of the first data storage area.

In an embodiment, the garbage collection setting module 430 may change the garbage collection execution condition according to the threshold update frequency. As a specific example, when the threshold update frequency is high, the garbage collection setting module 430 may set the garbage collection execution conditions (e.g., the number of invalid pages or valid pages) of the first and second data storage area such that the difference between the number of invalid pages or valid pages of the first data storage area and the second data storage area is large. Furthermore, when the threshold update frequency is low, the garbage collection setting module 430 may set the garbage collection execution conditions (e.g., the number of invalid pages or valid pages) of the first and second data storage area such that the difference between the number of invalid pages or valid pages of the first data storage area and the second data storage area is small.

The second control module 440 may set the garbage collection execution conditions for the plurality of data storage areas included in the nonvolatile memory apparatus 100. As a specific example, the second control module 440 may control the nonvolatile memory apparatus 100 to perform the garbage collection operation according to the garbage collection execution conditions set differently for the first data storage area and the second data storage area.

FIG. 5 is a flowchart of an operating method of the data storage device in accordance with an embodiment.

Referring to FIG. 5, in step S510, update frequency of data is determined. As a specific example, the data storage device 10 may determine the update frequency of data stored in the data storage area of the nonvolatile memory apparatus 100.

In an embodiment, the data storage device 10 may determine the update frequency of the data based on the number of references of a logical address referred to in order to update the data.

In step S520, the data is moved. As a specific example, the data storage device 10 may move the data based on the determined update frequency. For example, the data storage device 10 may move the data such that hot data having update frequency equal to or more than the preset threshold update frequency and data having update frequency equal to or less than the preset threshold update frequency are separately stored.

In an embodiment, the data storage device 10 may move the data such that data having update frequency exceeding the preset threshold update frequency among the data stored in the first data storage area is stored in the second data storage area.

In an embodiment, the data storage device 10 may move the data when the garbage collection is performed.

In an embodiment, when the data is updated, the data storage device 10 may move the data.

In step S530, a garbage collection execution condition is set. As a specific example, when the data is separately stored in the data storage areas based on the update frequency, the data storage device 10 may differently set the number of invalid data or the number of valid data, which is the garbage collection execution condition of each data storage area.

In an embodiment, the data storage device 10 may set the number of invalid data, which is the garbage collection execution condition of the data storage area storing hot data having high update frequency, to be large, or set the number of valid data, which is the garbage collection execution condition of the data storage area storing hot data having high update frequency, to be small.

In an embodiment, the data storage device 10 may set the number of invalid data, which is the garbage collection execution condition of the data storage area storing data having low update frequency, to be small, or set the number of valid data, which is the garbage collection execution condition of the data storage area storing data having low update frequency, to be large.

In step S540, the garbage collection is performed. The data storage device 10 may perform the garbage collection for the data storage area satisfying the set garbage collection execution condition.

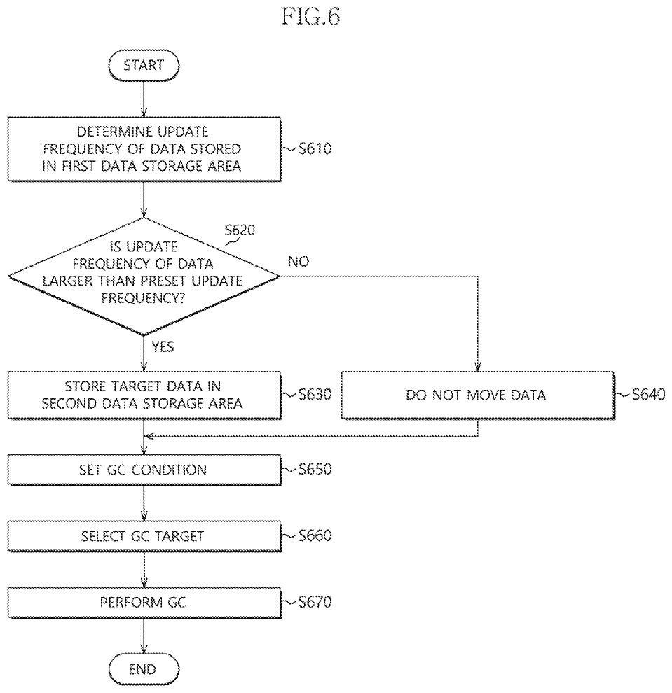

FIG. 6 is a flowchart of the operating method of the data storage device in accordance with an embodiment.

In step S610, update frequency of data is determined. As a specific example, the data storage device 10 may determine the update frequency of data stored in the data storage area of the nonvolatile memory apparatus 100.

In an embodiment, the data storage device 10 may determine the update frequency based on a logical address of data stored in the first data storage area. For example, since the logical address of the data is referred to in order to update the data stored in the nonvolatile memory apparatus 100, the data storage device 10 may determine the update frequency of the data based on the number of references of the logical address.

In step S620, whether to move the data is determined. As a specific example, the data storage device 10 may determine whether to move the data stored in the first data storage area to the second data storage area by comparing the update frequency of the data stored in the first data storage area with the preset threshold update frequency. For example, the data storage device 10 may allow hot data, which is data having update frequency exceeding the preset threshold update frequency among the data stored in the first data storage area, to be stored in the second data storage area.

In step S630, the hot data is stored in the second data storage area. As a specific example, the data storage device 10 may perform a write operation for storing the data of first data, which has been determined to be moved to the second data storage area, in the second data storage area.

In an embodiment, the data storage device 10 may perform the write operation for storing the hot data in the second data storage area when performing the garbage collection for the first data storage area. This is because, when the garbage collection for the first data storage area is performed, the write operation for storing the data stored in the first data storage area in another data storage area is performed.

In an embodiment, the data storage device 10 may perform the write operation for storing the hot data in the second data storage area when updating the hot data. This is because, in order to update the data stored in the first data storage area, a write operation for storing updated data in another data storage area is performed.

In step S640, the data storage device 10 may determine not to move data, which has update frequency equal to or less than the preset threshold update frequency among the data stored in the first data storage area, to the second data storage area. This is for distinguishing the data storage areas, where the data is stored, from each other according to the update frequency.

In step S650, a garbage collection execution condition is set. As a specific example, the data storage device 10 may differently set the number of invalid pages or the number of valid pages for the execution of garbage collection for each data storage area based on the update frequency of the data stored in the data storage area. When compared to the first data storage area in which non-hot data is stored, a less amount of valid data may be stored in the second data storage area in which the hot data is stored. Therefore, the less amount of valid data of the second data storage area may be moved during the garbage collection operation, which may cause a reduced number of write operations during the garbage collection operation. The reduced number of write operations may lead to the extended lifetime of the data storage device 10.

In an embodiment, the data storage device 10 may set the number of invalid data, which is the garbage collection execution condition of the second data storage area, to be larger than the number of invalid data which is the garbage collection execution condition of the first data storage area.

In an embodiment, the data storage device 10 may set the number of valid data, which is the garbage collection execution condition of the second data storage area, to be smaller than the number of valid data which is the garbage collection execution condition of the first data storage area.

In step S660, a garbage collection target is selected. When an available data storage area is not sufficient, the data storage device 10 performs the garbage collection for ensuring a data storage area. That is, the data storage device 10 may select a data storage area, which satisfies a garbage collection execution condition among data storage areas having previously stored data, as a target block (a sacrificial block) to be subjected to the garbage collection. In accordance with an embodiment, since the update frequency of data stored in the second data storage area is high so that the number of valid data of the data stored in the second data storage area is highly likely to be smaller than that of the first data storage area, the second data storage area may be selected as the target to be subjected to the garbage collection.

In step S670, the data storage device 10 may perform the garbage collection for the data storage area selected as the target to be subjected to the garbage collection.

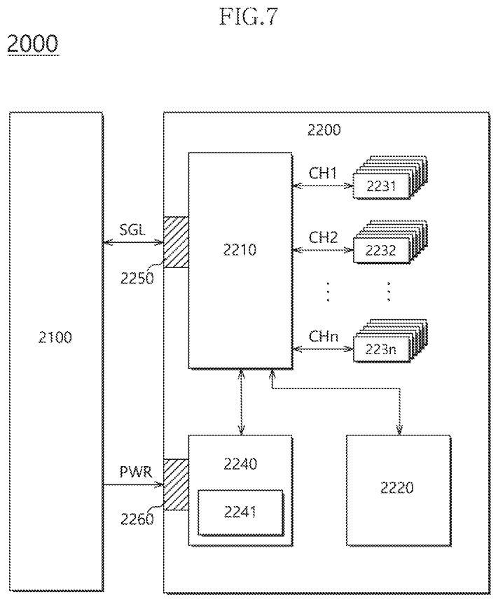

FIG. 7 is an exemplary diagram illustrating a data processing system including a solid state drive (SSD) in accordance with an embodiment. Referring to FIG. 7, a data processing system 2000 may include a host device 2100 and a solid state drive (hereinafter, referred to as SSD) 2200.

The SSD 2200 may include a controller 2210, a buffer memory apparatus 2220, nonvolatile memory apparatuses 2231 to 223n, a power supply 2240, a signal connector 2250, and a power connector 2260.

The controller 2210 may control all operations of the SSD 2200.

The buffer memory apparatus 2220 may temporarily store data to be stored in the nonvolatile memory apparatuses 2231 to 223n, Furthermore, the buffer memory apparatus 2220 may temporarily store the data read from the nonvolatile memory apparatuses 2231 to 223n. The data temporarily stored in the buffer memory apparatus 2220 may be transmitted to the host device 2100 or the nonvolatile memory apparatuses 2231 to 223n under the control of the controller 2210.

The nonvolatile memory apparatuses 2231 to 223n may be used as a storage medium of the SSD 2200. The nonvolatile memory apparatuses 2231 to 223n may be electrically connected to the controller 2210 through a plurality of channels CH1 to CHn. One or more nonvolatile memory apparatuses may be electrically connected to one channel. The nonvolatile memory apparatuses electrically connected to one channel may be electrically connected to substantially the same signal bus and data bus.

The power supply 2240 may provide power PWR inputted through the power connector 2260 to the inside of the SSD 1200. The power supply 2240 may include an auxiliary power supply 2241. The auxiliary power supply 2241 may supply power such that the SSD 2200 is normally terminated when sudden power off occurs. The auxiliary power supply 2241 may include high-capacity capacitors capable of charging the power PWR.

The controller 2210 may exchange a signal SGL with the host device 2100 through the signal connector 2250. The signal SGL may include a command, an address, data and the like. The signal connector 2250 may be composed of various types of connectors according to an interface method between the host device 2100 and the SSD 2200.

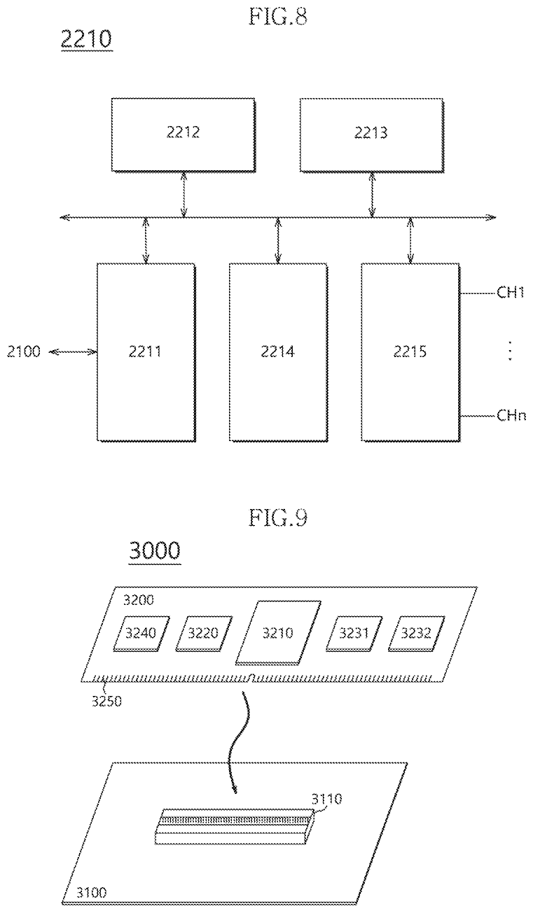

FIG. 8 is an exemplary diagram illustrating the controller of FIG. 7. Referring to FIG. 8, the controller 2210 may include a host interface unit 2211, a control unit 2212, a random access memory 2213, an error correction code (ECC) unit 2214, and a memory interface unit 2215.

The host interface unit 2211 may serve as an interface between the host device 2100 and the SSD 2200 according to the protocol of the host device 2100. For example, the host interface unit 2211 may communicate with the host device 2100 through any one of a variety of protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCIe), and a universal flash storage (UFS). Furthermore, the host interface unit 2211 may perform a disk emulation function that enables the host device 2100 to recognize the SSD 2200 as a general purpose data storage device 10, for example, as a hard disk drive (HDD).

The control unit 2212 may analyze and process the signal SGL inputted from the host device 2100. The control unit 2212 may control the operations of internal function blocks according to firmware or software for driving the SSD 2200. The random access memory 2213 may be used as a working memory for driving such firmware or software.

The error correction code (ECC) unit 2214 may generate parity data of data to be transmitted to the nonvolatile memory apparatuses 2231 to 223n. The generated parity data may be stored in the nonvolatile memory apparatuses 2231 to 223n together with the data. On the basis of the parity data, the error correction code (ECC) unit 2214 may detect an error of the data read from the nonvolatile memory apparatuses 2231 to 223n. When the detected error is within a correctable range, the error correction code (ECC) unit 2214 may correct the detected error.

The memory interface unit 2215 may provide a control signal, such as a command and an address, to the nonvolatile memory apparatuses 2231 to 223n under the control of the control unit 2212. Furthermore, the memory interface unit 2215 may exchange data with the nonvolatile memory apparatuses 2231 to 223n under the control of the control unit 2212. For example, the memory interface unit 2215 may provide the nonvolatile memory apparatuses 2231 to 223n with data stored in the buffer memory apparatus 2220 or provide the buffer memory apparatus 2220 with data read from the nonvolatile memory apparatuses 2231 to 223n.

FIG. 9 is an exemplary diagram illustrating a data processing system including a data storage device in accordance with an embodiment. Referring to FIG. 9, a data processing system 3000 may include a host device 3100 and a data storage device 3200.

The host device 3100 may be configured in the form of a board such as a printed circuit board. Although not illustrated in the drawing, the host device 3100 may include internal function blocks for performing the functions of the host device.

The host device 3100 may include an access terminal 3110 such as a socket, a slot, and a connector. The data storage device 3200 may be mounted to the access terminal 3110.

The data storage device 3200 may be configured in the form of a board such as a printed circuit board. The data storage device 3200 may be called a memory module or a memory card. The data storage device 3200 may include a controller 3210, a buffer memory apparatus 3220, nonvolatile memory apparatuses 3231 and 3232, a power management integrated circuit (PMIC) 3240, and an access terminal 3250.

The controller 3210 may control all operations of the data storage device 3200. The controller 3210 may be configured in the same manner as the controller 2210 illustrated in FIG. 8.

The buffer memory apparatus 3220 may temporarily store data in the nonvolatile memory apparatuses 3231 and 3232. Furthermore, the buffer memory apparatus 3220 may temporarily store the data read from the nonvolatile memory apparatuses 3231 and 3232. The data temporarily stored in the buffer memory apparatus 3220 may be transmitted to the host device 3100 or the nonvolatile memory apparatuses 3231 and 3232 under the control of the controller 3210.

The nonvolatile memory apparatuses 3231 and 3232 may be used as a storage medium of the data storage device 3200.

The PMIC 3240 may provide power inputted through the access terminal 3250 to the inside of the data storage device 3200. The PMIC 3240 may manage the power of the data storage device 3200 under the control of the controller 3210.

The access terminal 3250 may be electrically connected to the access terminal 3110 of the host device. A signal such as a command, an address, and data, and power may be transferred between the host device 3100 and the data storage device 3200 through the access terminal 3250. The access terminal 3250 may be configured in various forms according to an interface method between the host device 3100 and the data storage device 3200. The access terminal 3250 may be disposed on one side of the data storage device 3200.

FIG. 10 is an exemplary diagram illustrating a data processing system including a data storage device in accordance with an embodiment. Referring to FIG. 10, a data processing system 4000 may include a host device 4100 and a data storage device 4200.

The host device 4100 may be configured in the form of a board such as a printed circuit board. Although not illustrated in the drawing, the host device 4100 may include internal function blocks for performing the functions of the host device.

The data storage device 4200 may be configured in a surface mount package form. The data storage device 4200 may be mounted to the host device 4100 through solder balls 4250. The data storage device 4200 may include a controller 4210, a buffer memory apparatus 4220, and a nonvolatile memory apparatus 4230.

The controller 4210 may control all operations of the data storage device 4200. The controller 4210 may be configured in the same manner as the controller 2210 illustrated in FIG. 8.

The buffer memory apparatus 4220 may temporarily store data in the nonvolatile memory apparatus 4230. Furthermore, the buffer memory apparatus 4220 may temporarily store the data read from the nonvolatile memory apparatus 4230. The data temporarily stored in the buffer memory apparatus 4220 may be transmitted to the host device 4100 or the nonvolatile memory apparatus 4230 under the control of the controller 4210.

The nonvolatile memory apparatus 4230 may be used as a storage medium of the data storage device 4200.

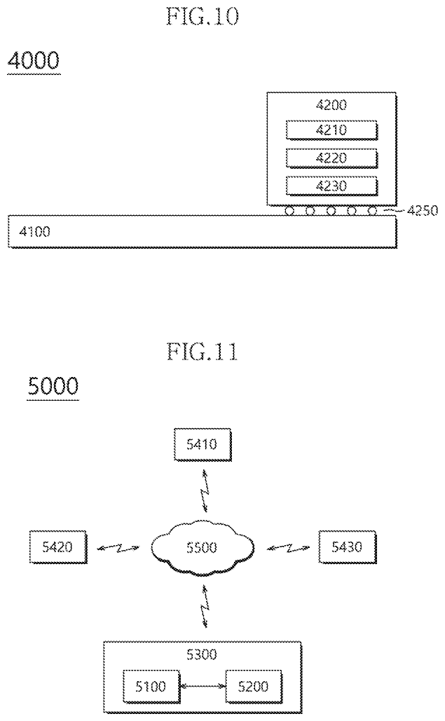

FIG. 11 is an exemplary diagram illustrating a network system 5000 including a data storage device in accordance with an embodiment. Referring to FIG. 11, the network system 5000 may include a server system 5300 and a plurality of client systems 5410, 5420, and 5430, which are electrically connected to one another, through a network 5500.

The server system 5300 may service data in response to requests of the plurality of client systems 5410, 5420, and 5430. For example, the server system 5300 may store data provided from the plurality of client systems 5410, 5420, and 5430. In another example, the server system 5300 may provide data to the plurality of client systems 5410, 5420, and 5430.

The server system 5300 may include a host device 5100 and a data storage device 5200. The data storage device 5200 may be configured with the data storage device 10 of FIG. 1, the data storage device 2200 of FIG. 7, the data storage device 3200 of FIG. 9, and the data storage device 4200 of FIG. 10.

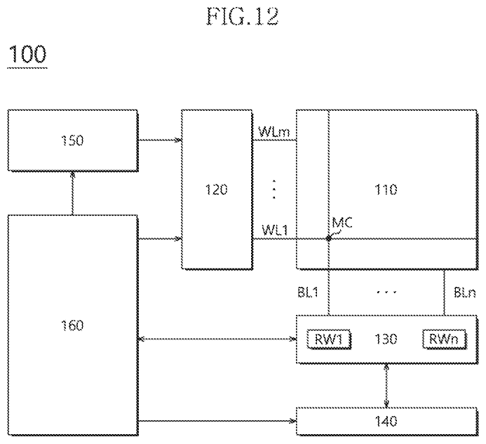

FIG. 12 is an exemplary block diagram illustrating a nonvolatile memory apparatus included in a data storage device in accordance with an embodiment. Referring to FIG. 12, a nonvolatile memory apparatus 100 may include a memory cell array 110, a row decoder 120, a column decoder 130, a data read/write block 140, a voltage generator 150, and a control logic 160.

The memory cell array 110 may include memory cells MC arranged in intersection areas of word lines WL1 to WLm and bit lines BL1 to BLn.

The row decoder 120 may be electrically connected to the memory cell array 110 through the word lines WL1 to WLm. The row decoder 120 may operate under the control of the control logic 160. The row decoder 120 may decode an address provided from an external device (not illustrated). The row decoder 120 may select and drive the word lines WL1 to WLm on the basis of the decoding result. For example, the row decoder 120 may provide the word lines WL1 to WLm with a word line voltage provided from the voltage generator 150.

The data read/write block 140 may be electrically connected to the memory cell array 110 through the bit lines BL1 to BLn. The data read/write block 140 may include read/write circuits RW1 to RWn corresponding to the bit lines BL1 to BLn, respectively. The data read/write block 140 may operate under the control of the control logic 160. The data read/write block 140 may operate as a write driver or a sense amplifier according to an operation mode. For example, the data read/write block 140 may operate as a write driver that stores data provided from an external device in the memory cell array 110 during a write operation. In another example, the data read/write block 140 may operate as a sense amplifier that reads data from the memory cell array 110 during a read operation.

The column decoder 130 may operate under the control of the control logic 160. The column decoder 130 may decode an address provided from an external device. The column decoder 130 may electrically connect the read/write circuits RW1 to RWn of the data read/write block 140, which correspond to the bit lines BL1 to BLn, respectively, to data input/output lines (or data input/output buffers), on the basis of the decoding result.

The voltage generator 150 may generate voltages to be used in the internal operations of the nonvolatile memory apparatus 100. The voltages generated by the voltage generator 150 may be applied to the memory cells of the memory cell array 110. For example, a program voltage generated during a program operation may be applied to word lines of memory cells subjected to the program operation. In another example, an erase voltage generated during an erase operation may be applied to well regions of memory cells subjected to the erase operation. In another example, a read voltage generated during a read operation may be applied to word lines of memory cells subjected to the read operation.

The control logic 160 may control all operations of the nonvolatile memory apparatus 100 on the basis of a control signal provided from an external device. For example, the control logic 160 may control the read, write, and erase operations of the nonvolatile memory apparatus 100.

While various embodiments have been described above, it will be understood to those skilled in the art that the embodiments described are examples only. Accordingly, the controller, the data storage device, and the operating method thereof described herein should not be limited based on the described embodiments.

What is claimed is:

1. A data storage device comprising:
a nonvolatile memory apparatus including a plurality of memory blocks; and
a controller configured to control the nonvolatile memory apparatus,
wherein the controller is configured to:
determine update frequency for data stored in first memory blocks of the plurality of memory blocks,
control the nonvolatile memory apparatus to store hot data among the data stored in the first memory blocks in second memory blocks of the plurality of memory blocks, the hot data indicating data having the update frequency exceeding preset threshold update frequency,
set garbage collection execution conditions of the first memory blocks and the second memory blocks to be different from each other, and
control the nonvolatile memory apparatus to perform garbage collection for the first memory blocks and the second memory blocks according to the garbage collection execution conditions for the first memory blocks and the second memory blocks set to be different from each other.

2. The data storage device according to claim 1, wherein the controller determines the update frequency based on a number of times of referring to logical addresses of the data stored in the first memory blocks during a write operation.

3. The data storage device according to claim 1, wherein the controller controls the nonvolatile memory apparatus to store hot data among the data stored in the first memory blocks in second memory blocks during a write operation for updating the data stored in the first memory blocks.

4. The data storage device according to claim 1, wherein the controller controls the nonvolatile memory apparatus to store the hot data in the second memory blocks when the garbage collection is performed for the first memory blocks.

5. The data storage device according to claim 1, wherein the controller controls the nonvolatile memory apparatus to perform the garbage collection by setting as the garbage collection execution condition the number of invalid pages or the number of valid pages included in each of the plurality of memory blocks.

6. The data storage device according to claim 5, wherein the controller sets the garbage collection execution condition of the second memory blocks such that a difference between the garbage collection execution condition of the first memory blocks and the garbage collection execution condition of the second memory blocks increases as the threshold update frequency is high.

7. The data storage device according to claim 6, wherein the controller changes the threshold update frequency based on the number of erases or writes of the first memory blocks.

8. The data storage device according to claim 7, wherein the controller changes the threshold update frequency to be low when the number of erases or writes of the first memory blocks is high, and changes the threshold update frequency to be high when the number of erases or writes of the first memory blocks is low.

9. The data storage device according to claim 6, wherein, when the number of invalid pages is set as the garbage collection execution condition, the controller sets the number of invalid pages, which is the garbage collection execution condition of the second memory blocks, to be larger than the number of invalid pages which is the garbage collection execution condition of the first memory blocks.

10. The data storage device according to claim 6, wherein, when the number of valid pages is set as the garbage collection execution condition, the controller sets the number of valid pages, which is the garbage collection execution condition of the second memory blocks, to be smaller than the number of valid pages which is the garbage collection execution condition of the first memory blocks.

11. A controller for controlling a nonvolatile memory apparatus including a plurality of data storage areas, the controller comprising:
an update frequency determination module configured to determine update frequency for data stored in first memory blocks of the plurality of memory blocks;
a first control module configured to control the nonvolatile memory apparatus to store hot data among the data stored in the first memory blocks in second memory blocks of the plurality of memory blocks, the hot data indicating data having the update frequency exceeding preset threshold update frequency;
a garbage collection setting module configured to set garbage collection execution conditions of the first memory blocks and the second memory blocks to be different from each other; and
a second control module configured to control the nonvolatile memory apparatus to perform garbage collection for the first memory blocks and the second memory blocks according to the garbage collection execution conditions for the first memory blocks and the second memory blocks set to be different from each other.

12. The controller according to claim 11, wherein the update frequency determination module determines the update frequency based on a number of times of referring to logical addresses of the data stored in the first memory blocks during a write operation.

13. The controller according to claim 11, wherein the first control module controls the nonvolatile memory apparatus to store hot data among the data stored in the first memory blocks in second memory blocks during a write operation for updating the data stored in the first memory blocks.

14. The controller according to claim 11, wherein the first control module controls the nonvolatile memory apparatus to store the hot data in the second memory blocks when the garbage collection is performed for the first memory blocks.

15. The controller according to claim 11, wherein the garbage collection setting module sets as the garbage collection execution condition the number of invalid pages or the number of valid pages included in each of the plurality of memory blocks.

16. The controller according to claim 15, wherein the garbage collection setting module sets the garbage collection execution condition of the second memory blocks such that a difference between the garbage collection execution condition of the first memory blocks and the garbage collection execution condition of the second memory blocks increases as the threshold update frequency is high.

17. The controller according to claim 16, wherein the first control module changes the threshold update frequency based on the number of erases or writes of the first memory blocks.

18. The controller according to claim 17, wherein the first control module changes the threshold update frequency to be low when the number of erases or writes of the first memory blocks is high, and changes the threshold update frequency to be high when the number of erases or writes of the first memory blocks is low.

19. The controller according to claim 16, wherein, when the number of invalid pages is set as the garbage collection execution condition, the garbage collection setting module sets the number of invalid pages, which is the garbage collection execution condition of the second memory blocks, to be larger than the number of invalid pages which is the garbage collection execution condition of the first memory blocks.

20. The controller according to claim 16, wherein, when the number of valid pages is set as the garbage collection execution condition, the garbage collection setting module sets the number of valid pages, which is the garbage collection execution condition of the second memory blocks, to be smaller than the number of valid pages which is the garbage collection execution condition of the first memory blocks.
